(19) United States
(12) Patent Application Publication
(10) Pub. No.: US 2010/0027851 A1
(43) Pub. Date: Feb. 4, 2010

(54) Apparatus, method and process for the stochastic marking and tracking of printed products

(75) Inventors: Thomas Walther, Sankt Gallen (CH); Bernhard Wirnitzer, Hemsbach (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: MAN ROLAND DRUCKMASCHINEN AG, Offenbach am Main (DE)

(21) Appl. No.: 12/447,222

(22) PCT Filed: Oct. 19, 2007
(86) PCT No.: PCT/EP07/09089

§ 371 Date: Sep. 4, 2009

(30) Foreign Application Priority Data
Oct. 26, 2006 (DE) 10 2006 050 553.0

(51) Int. Cl. G06K 9/00; G06K 15/02; H04N 1/44

(52) U.S. Cl. 382/112; 382/100; 358/3.28; 380/243

(57) ABSTRACT

A system and method records and identifies certain attributes of printed products for verifying their authentication and for tracking individual printed products or copies of printed products. In embodiment of the invention, a static code with redundant information and with high spatial resolution is applied on the printed product and the optoelectronic detection of the printed image on the printed product is carried out by means of a line-scan or area-scan camera or a laser scanner within a printing machine or an additional processing machine. The data are decoded after their acquisition by means of the optoelectronic detection device and the decoded data are used for characterizing an individual printed image and/or the printing process.

### CROSS-REFERENCE TO RELATED APPLICATIONS

This patent application is the national phase of PCT/EP2007/009089, filed Oct. 19, 2007, which claims the benefit of German Patent Application No. 10 2006 050 553.0, filed Oct. 26, 2006, both of which are herein incorporated by reference in their entireties.

### FIELD OF THE INVENTION

The present invention relates generally to the making of printed products and, more particularly, to the stochastic marking of printed products in a method for ascertaining their authenticity, in which characteristic attributes of the print and the printing substrate are respectively identified within a printed code.

### BACKGROUND OF THE INVENTION

The individual identification of printed products is desirable for two reasons: the positive detection of counterfeits, as well as the ability to track each individual print or print copy along the manufacturing chain from the manufacture of the package to the end user. However, positive identifications also play an important role in payment transactions and coupons. Another issue that involves a positive identification of a printed product is the requirement to track a product from the manufacture to logistics and distribution. This type of documentation is prescribed for an increasing number of products.

One known method of identifying products is the use of bar codes that are printed on packages. However, bar codes are normally static, i.e., they do not identify the individual product, but only a group of products.

Individual identifications such as variable bar codes or sequences of alphanumeric characters can be printed on printed products with a mechanical numbering box or an inkjet printer. In this case, the printing inks or inks may be visible or invisible to the human eye. The disadvantages of these methods are the high investment and operating costs of such apparatuses and the low level of anti-counterfeiting protection. Even if the length of the individual printed code is kept confidential, it can be easily reconstructed, for example, by collecting used printed products.

One solution for realizing an individual identification is RFID (radio-frequency-identification) tags that are affixed to the printed product, for example, in the form of a label. These tags may carry a distinct identification number on a chip that makes it possible to realize the identification. However, these RFID tags are very costly (between 0.20-0.50 Euros) and therefore disproportionately expensive in comparison with the manufacturing cost of a printed product, e.g., a package. Consequently, RFID solutions according to the current state of the art are reasonable only if other advantages with respect to logistics and distribution can be realized.

Another solution is the complete printing or imprinting of variable data with digital printing methods that make it possible to provide each printed product with an individual attribute, such as a variable code or information concealed in a printed image. The digital printing of printed products according to the current state of the art is not competitive for bulk printed matter such as packages. The subsequent imprinting of variable data on bulk printed matter requires additional production steps and also involves high costs. The aforementioned imprinting of digital data on printed products produced with static methods is used only in practical applications if additional benefits can be achieved, e.g., by imprinting a delivery address, or if the ink coating is very thick to prevent counterfeiting.

The use of such a digitally printed number as anti-counterfeit protection is disclosed, for example, in EP 1 420 381 A1. A serial number is printed on the package and, at the same time, another characterizing attribute of the package is detected, e.g., a gluing edge. Both attributes are combined in a data mapper, which then allows a positive assignment of the package by matching the number and the characterizing attribute with the dataset.

One known method for protecting static printed data is the alteration of the print content, for example, by replacing lines with so-called nanotext or replacing dots with symbols. One such method for modifying printed images by means of a combination with a second piece of information is known, for example, from EP 1 345 193 A2. Other methods that have become known under the term digital watermarks are disclosed, for example, in US 2004/0039914 A1, US 2004/0101159 A1 and U.S. Pat. No. 7,003,132 B2. Although digital watermarks make it possible to ascertain the authenticity of a product, they do not allow an individual identification of a particular product.

U.S. Pat. No. 6,808,118 B2 discloses a coding of the print by means of a deliberate variation of the color of the individual dots/pixels. With respect to high-volume printing, several different methods have been developed that make it possible to ascertain the authenticity with simple typographical methods. For example, WO 2006/087351 A2 describes a method in which an invisible or only slightly visible pattern is placed over a printed image, wherein the dots are modulated by varying the quantity of the applied substance.

Other known anti-counterfeiting methods utilize individualized holograms or other safety features that are subsequently added to the print. However, these identifications are very costly and therefore significantly increase the price of the printed product.

One common aspect of all security features mentioned thus far is that they either require special printing methods, the addition of security elements or a special manipulation of prepress data. This is always associated with added costs and normally cannot be carried out by a standard printing company. For example, the manipulation of prepress data is normally carried out by special firms or with the aid of special software.

Another disadvantage of these methods is that, in order to ascertain the authenticity, they frequently require special evaluation devices that are not always available everywhere. When using a security feature that can only be detected under UV light, for example, a hologram with integrated security features requires a corresponding lamp. If this lamp is not available, for example, during the course of a customs inspection, the authenticity cannot be ascertained. Another disadvantage of all these methods is that they normally differ individually for each product and the person carrying out the identification must know the feature to be checked on the corresponding product. In a number of known anti-counterfeiting methods, this requirement conflicts with the desire for fast and nonstop verifications.

In other known methods, certain attributes of a printed product are detected by means of an image detection device, and these attributes are stored in a database in coded or uncoded form. These attributes can then be scanned with a conventional scanner provided in most offices and matched to the dataset stored in the database. A method of this type is described in DE 101 62 537 A1, wherein the disadvantage of this method is that specific particles must be applied during a printing process or mixed into the paper. Once again, this requires special methods and materials and therefore is not suitable for universal use. Here, the person carrying out the identification also must know the attribute and the corresponding evaluation method.

DE 103 45 669 A1 discloses a method for ascertaining authenticity based on characteristic attributes of the print or the printing substrate within a printed code. This method exploits the fact that any actual data carrier will feature random structures to a varying extent. The reason for this is that there are inhomogeneities in the printing substrate, such as the stochastic distribution of the paper fibers of a paper, or inhomogeneities that are inherent to the printing process. The highest security possible is achieved with a combination of the substrate attributes and the substrate/print interaction.

Even a photographic reproduction of any resolution that also includes the influence of the aforementioned random processes can thereby be identified as a counterfeit.

This process provides the significant advantage that no special and costly attributes are used, but only the stochastic variations of the printing process evaluated by the interactions between the printing process and the substrate. This is advantageous since the variable costs for the anti-counterfeiting protection are exceptionally low and only involve the expenses for the data acquisition, the data processing and the data storage, which are extremely low in comparison with special security features provided as anti-counterfeiting protection. Another advantage of this method is that it is counterfeit-proof and therefore can be universally used. An examination authority therefore requires only one data acquisition device that scans and matches the safety code to a code stored in a database.

DE 10 2005 013 962 describes a method for the simple and inexpensive manufacture of counterfeit-protected paper documents with content protection and copy detection. The copy detection is realized with the aid of a special numbered document paper, the locally random structural component of which is previously automatically detected and stored in a database under the number. The user then stores the digitized data of the document together with the data of the random structural component in encoded form on the document in the form of a matrix print data storage.

WO 2006/013037 A1 describes a matrix print data storage that is particularly suitable for realizing the above-described methods. DE 199 26 194 and DE 199 26 197 describe methods for decoding such a matrix print data storage. These publications for the first time describe how known printing symbols are used for the equalization of transmission channels and how geometric distortions are resolved by means of modeling.

Although the methods described and used in DE 103 45 669 A1, DE 10 2005 013 962 and WO 2006/013037 A1 disclose basic ways to realize individual identification, there are no indications regarding their integration into machines and manufacturing processes for series production.

In particular, no reference has addressed the following factors:
the high-speed acquisition and calculation of the statistical parameters during the manufacturing process at a processing speed of several meters/second
the calculation and storage of the parameters in the millisecond range
the monitoring of the quality of the individual identification
the size of the required data storages or databases
the variation of the ink film by means of drying processes and
the consideration of different known conversion methods in printing processes.

### OBJECTS AND SUMMARY OF THE INVENTION

The invention provides a method for the stochastic marking of printed products and for ascertaining their authenticity, wherein characteristic attributes of the print and the printing substrate are respectively detected within a printed code, wherein the invention also aims to adapt said method to the requirements in the process flow of the printing industry and furthermore to allow the subsequent tracking of each individual print.

It is an object of the invention to provide a method for identifying attributes of printed products for their authentication and for tracking individual printed products or copies of printed products by scanning a printed code with an optoelectronic detection device, wherein a static code with redundant information and with high spatial resolution is applied on the printed product, and the optoelectronic detection of the printed image on the printed product is carried out by means of a line-scan or area-scan camera or a laser scanner within a printing machine or an additional processing machine such as a web-fed or sheet-fed printing machine or a lift-punching machine or a punching machine with rotary tools or a folding box gluing machine or a collating machine for printed products or a packaging line or a machine for setting folding boxes upright or in a filling or packaging machine.

It is a further object of the invention to enable decoding of the encoded data after the acquisition of the data of the printed code, wherein the information contained in the code is determined based on an error correction and the variance caused by the printing process is subsequently determined based on the known sequence of symbols, wherein the systematic and the random component are distinguished from one another, and wherein the systematic component describes the quality of the printing process and the random component describes the uniqueness of the individual print.

Other objects and advantages of the invention will become apparent upon reading the following detailed description.

### BRIEF DESCRIPTION OF THE DRAWING

The FIGURE is a schematic view of a laser beam split into two orthogonal planes of polarization formed by means of diffraction to scan a matrix print data storage in accordance with an embodiment of the invention.

### DESCRIPTION OF THE PREFERRED EMBODIMENTS

According to the invention, stochastic parameters of the printing process and/or the paper structure are recorded by means of an image recording device at one point of the manufacturing process of a package, wherein these stochastic parameters are then analyzed and coded in a subsequent processing step and stored in the form of a code in a database and/or on a printed data storage in coded or uncoded form. The invention furthermore proposes a method for identifying printed products.

In a printing process, different partial images of different printing inks are assembled into a complete image. According to the invention, a static data code or a static identification is also printed in one of these prints and additionally evaluated with respect to certain structural components at certain locations. Structural components may consist of the random paper structure or substrate structure, the random interaction between the print and the substrate structure or random irregularities in the printed image. According to the invention, any combinations of the above-described attributes can also be chosen for the evaluation. The fundamental idea that was already implemented for individual segments, such as the protection of certificates, is based on the fact that each printed image, as well as the substrate itself, has an individual structure that is difficult to reproduce, for example, due to minimal process irregularities, interferences in ink absorption by the substrate material.

The invention aims to exploit this individual print and substrate structure as an individual attribute for the originality of each product.

For example, in an embodiment of the invention, the following features are required:

a) printing a code with redundant information and with high spatial resolution,

b) optoelectronic detection of the printed image with a line-scan or area-scan camera or with a laser scanner,

c) decoding the printed code, and

d) characterization of each individual printed image and/or the printing process based on the decoding.

The printing of a code (a) with redundant information and with high spatial resolution is realized, for example, in the form of a 2D matrix code (preferably a PDF-417 or datamatrix code), a matrix print data storage (as described in WO 2006/013037) or any other redundant sequence of symbols that may also consist of letters of a defined font (microprint). The only important factor here is that the spatial resolution used advantageously pushes the envelope of the printing process (i.e., is close to the limit of the capabilities of the printing process) used or even the production of the printing plate in the prepress phase (e.g., 2400 dpi (dots per inch) in offset printing with a printing plate exposure with 2540 dpi or 1200 dpi with adequate laser printing). The fact that the code is printed with high spatial resolution does not necessarily mean that the scanning devices also must have high spatial resolution. For example, it is quite possible that a code is printed at 2400 dpi, but can be scanned at 300 dpi. For example, a cell of the datamatrix code may be composed of numerous pixels such that each cell has high edge definition. A few pixels can then be omitted or even added at the edge in each cell without rendering the code unreadable. In this case, the omission or addition of the pixels can be conventionally realized in accordance with the initially cited state of the art in order to cause deliberate bleeding of the printing ink.

The redundancy is added in such a way that error correction can be carried out (FEC, forward error correction). This can be realized with several known telecommunication methods (such as those disclosed in S. Haykin: Communication Systems, John Wiley & Sons, New York, 1994; J. G. Proakis: Digital Communications, McGraw-Hill, New York, 1995).

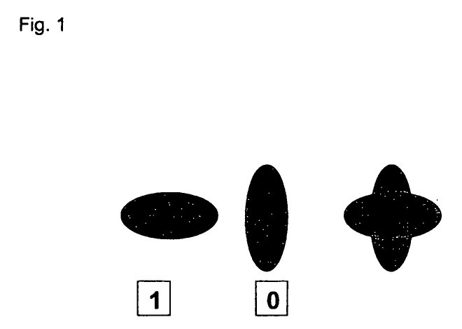

The optoelectronic recording of the printed image is realized in the printing machine or printer or in an additional processing or packaging machine with the aid of a line-scan or area-scan camera or a laser scanner. When using a laser scanner, a telecentric image is preferably used in order to improve the depth of field. When a laser scanner is used, the spot can be designed in an optimized fashion in the form of a signal-adapted filter (optically Matched Filter, MF). In this case, the spot is extended in accordance with the printed symbol, e.g., by means of diffraction elements in the beam path. If the matrix print data storage is composed of oval dots, the horizontal oval represents the code for a logical ONE and the vertical oval represents the code for a logical ZERO (see FIG. 1). The laser beam is split into two orthogonal planes of polarization that are respectively formed by means of diffraction in accordance with the logical ONE and ZERO. The matrix print data storage is scanned with the assembled cross of ovals. The directions of polarization are recorded separately in the detector and the signals are subtracted and evaluated with respect to greater than/less than zero. The laser scanner then already functions as a Matched-Filtered-Detector. A person skilled in the art will expand the concept to symbols with a more complex shape, e.g., with digitally calculated diffraction gratings (computer holograms). The laser scanner with MF reduces the data rate from the pixel level to the symbol level. In practical applications, symbols typically consist of 7×7 pixels such that the maximum data reduction is a factor of 49. A reduction of the data rate is particularly important in high-speed printing machines.

After the printed code has been decoded, it is known which information and therefore also which sequence of symbols was printed due to the error correction. The variance caused by the printing process can be determined based on the known sequence of symbols. In this case, one distinguishes between a systematic component and a random component as described in DE 103 45 669 and DE 199 26 194. Here, the systematic component describes the quality of the printing process, and the random component describes the individuality of each individual print. A digital random signal of very high quality can be very easily generated from the random component, e.g., by means of a binary conversion with the threshold value zero. Consequently, a random value is assigned to each printed symbol. The random signal generated in this way is hereafter referred to as canonical (or natural) stochastic coding (KSM).

The above-described canonical random signal is caused by the individual bleeding of the printing ink due to the paper structure or due to the individual application of the printing ink and has no amplitudes, and it cannot be counterfeited with the same printing process because of its natural origin. If the printed code were intentionally destroyed at certain locations (symbols), high values would appear in the random signal. These easily detectable high values cannot be used for copy detection purposes because they would be generated by a copy in the same fashion as the original.

Intentionally producing random irregularities or even destroying parts of the printed code has an unexpected, but very useful side effect: it allows a non-canonical stochastic coding (nKSM) for each print. This marking can be used for easily and quickly re-locating each print at a later time. Significant losses occur, for example, if process parameters are even briefly unobserved in an offset printing machine because good and bad prints can no longer be easily sorted out at a later time. In a stochastic marking, a data file with the data of the stochastic coding is delivered with the prints, wherein said data file contains information indicating whether a print is bad. The bad prints can then be sorted out in subsequent stages of the processing chain. Furthermore, the nKSM can be supplemented at arbitrary locations of the process chain for tracking purposes. For example, the end user could also sign on the code and transmit the data via mobile telephone such that the product is thereafter always identified as his property.

It is possible to distinguish between, and hence separate, KSM and nKSM based on the amplitude statistic of the basic signal. The (subsequent) application of an nKSM therefore does not interfere with the copy detection. Due to the error correction (FEC), the printed data storage is also not destroyed. However, nKSM allows a fast search for the assigned KSM in copy detection applications with an external database. This is necessary, for example, when counterfeit-protected packages are manufactured without another individual machine-made identification.

In an embodiment of the invention, therefore, the following inventive components are used to provide machines for the production of high-volume prints:

a) image recording optics with high depth of field, a line-scan camera, area-scan camera or laser scanner for the data acquisition,

b) an arithmetic and logic unit for calculating the KSM and/or nKSM, wherein the arithmetic and logic unit may form part of an intelligent camera or be integrated into an external module,

c) a display device for the quality monitoring of the KSM (the display of identification accuracy that is achieved) that is operated in the form of an independent display device or forms part of a printing machine control station, wherein the cross correlation of the KSM of different areas of a print or of different prints is calculated, for example, in the display device or in a separate arithmetic and logic unit, and the probability of two KSM being indistinguishable is estimated with known statistical methods.

Consequently, each machine operating in accordance with the method is provided with a display device that outputs information on how well the stochastic coding of the individual printed sheets can be distinguished.

If the print quality is excessively high, it becomes more difficult to distinguish the prints from one another. However, values for false acceptance rates (FAR) and false rejection rates (FRR) can be predicted quite well with statistical methods.

The operation therefore requires a display for outputting information from the code evaluation that indicates whether the process is running within the acceptable range and achieves the satisfactory FAR and FRR.

The described procedure ensures that an anti-counterfeiting protection with the desired safety level is realized for a predetermined quantity during production. If two prints have an indistinguishable or insufficiently distinguishable KSM, one print can be detected and marked in a different way based on the nKSM so that they can be sorted out in the printing machine or in a subsequent printing process.

The structural data can be acquired in a web-fed or sheet-fed printing machine by means of an image recording device, such as an area-scan or line-scan camera. If several copies are printed, several cameras are mounted relative to the copies over the width of the printing machine or displaced into corresponding recording positions. The recording of the printed code is realized by means of a trigger signal that indicates the recording position. The trigger signal can be obtained from a rotary encoder that is connected to the printing machine or a separate sensor that recognizes, for example, an edge or another marker in the printed image and triggers the recording. The recording may also be realized with one or more line-scan or area-scan cameras, wherein here the entire sheet is scanned and the relevant areas are subsequently delivered to the evaluation and coding based on the position coordinates of the code.

The web-fed or sheet-fed printing machines preferably consist of offset printing machines that feature at least one inking unit, one plate cylinder and one transfer cylinder.

The acquisition of the data in the printing machine provides the advantage that it occurs at the beginning of the value-added chain of the print production. If the data is acquired during printing, coded and forwarded to the brand goods producer, a reprint with the identical printing plates could also be identified as a counterfeit or unauthorized printed product.

One disadvantage of the measurement in the printing machine is that the interaction between the printing ink and the substrate may frequently not yet be completed. It is therefore recommended to dry or harden the printing ink by means of a drying device before the code(s) are scanned. If it concerns a printed product, it is also recommended to protect the printed product with a varnish because subsequent mechanical stresses, such as those of a folding box during the filling process, may render the code illegible. Due to the high data redundancy, the method is also immune to serious damage although a complete data loss due to damage cannot be entirely ruled out. It is therefore reasonable to seal the printed product, or a location of interest, with a protective varnish in this case.

This method is particularly suitable for radiation-hardening printing inks and varnishes that are dried under the influence of UV radiation or electron beams since these printing inks and varnishes no longer change with respect to their surface topography after the hardening process, whereas printing inks that dry penetratively or oxidatively are still subject to some structural changes due to the penetration process and the oxidative drying. This method is also particularly suitable for thermal printing, in which highly volatile oils are expelled after the printing process by means of a dryer. Similar to UV printing, no significant structural change occurs downstream of the thermal dryer. If the paper structure is only scanned in the intermediate spaces of the printed code, the scanning is not dependent on the structural character of the printed code and therefore suitable for all printing ink systems. In this case, the code merely serves as a scale for the measurement such that the measuring points can once again be quickly and reproducibly located.

In a sheet-fed printing machine, the measurements may be carried out in the sheet outlet of any printing or varnishing unit or in the region of the delivery. In a web-fed printing machine, the measurements are carried out on the web-shaped substrate at any location, preferably after the drying and, if applicable, the re-moistening of the web in a web-fed thermal printing machine.

When printing folding boxes, several copies are printed adjacent to and behind one another on the sheet. The copies must be decollated from the sheet and grooved such that an individual folding box can be subsequently formed. The decollating is normally realized by means of lift-punching or punching devices that operate with rotating tool cylinders. Alternatively to a measurement in the printing machine, the measurement could also take place in a punching machine. One advantage of such a measurement, among others, would be that the drying of the printing ink would already have progressed further and no further structural changes in the print would be expected.

The preferred measuring site according to the invention, insofar as the measurement is to be carried out during the manufacture of a folding box, is in the folding box gluing machine since an individual folding box is present at this location. Spoilage created during the printing or the punching process is already sorted out and copies rendered defective by the measurement or the gluing process can be transferred out of the gluing machine. The significant advantage of this measuring site can be seen in that the copies are individually fed to the measuring system such that one measuring system normally suffices for scanning all folding boxes. However, a measurement on a sheet with several copies normally also requires several measuring systems.

The measurement may also be carried out during the filling process of the package. Measurements could be carried out while the package is set upright or during the filling process in a packaging line. This measuring site provides the advantage that the complete data remains with one source and need not be transferred from the printing plant to the brand goods producer. However, it is disadvantageous in that the identification process takes place relatively late in the process chain. Another advantage of this measuring site is realized in that the packaging process frequently takes place more slowly than, for example, the gluing of the folding box, and in that the data acquisition expenditures are therefore usually lower. For example, this would make it possible to use less expensive cameras.

The printed image of the code is scanned with recording optics at all measuring points and projected and recorded on a line-scan or area-scan sensor. The recorded image can then either be stored in a database in the form of an image or directly forwarded to a unit for calculating the print data and/or paper data, which is implemented in the form of software or hardware. For reasons of efficiency, a hardware implementation of the acquisition and calculation algorithms is preferred in an embodiment of the invention. In a further embodiment of the invention, the recording process itself takes place under constant lighting conditions or preferably under flash or stroboscopic light.

After the calculation of the matrix data, a cryptography step is carried out with a secret key at the packaging manufacturer (alternative 1) or at the customer (alternative 2) that receives or independently acquires the 2D matrix data and codes this data with the secret key. The coded data is stored in a database that is preferably accessible via an Internet connection.

The end user (customer, customs, police, retail outlet) scans the code with a scanner, a webcam, a digital camera or a mobile communication device featuring a camera and transmits this data to the Internet portal. The 2D matrix data of the currently scanned code is calculated in the Internet application and used for comparison purposes. The data of the database is decoded by utilizing a public key and matched to the scanned data. The Internet application ideally controls the recording device such that the user requires no information other than the instruction to place the product with the code in front of or on the recording device. This results in a simple, reliable and universal anti-counterfeiting method that can be realized with very simple means. Hardly any additional costs are incurred for the application of security features.

One source of problems may be the relatively large quantity of data that is stored in the Internet database for large print runs. A sequential search or a tree-like search in the database may be sufficiently fast for small data quantities and therefore requires no additional ID-code. With large quantities, however, it is helpful to provide an ID-code that may consist of a variable number, a bar code, a sequence of alphanumeric characters or another individual attribute of a printed product that allows an individual identification of the printed product because the ID-marking makes it possible to directly access the dataset that should be used for the comparison with the currently acquired dataset. Access therefore is extremely fast.

The ID-code can be applied in the printing machine, in the punching machine, in the folding box gluing machine or in the packaging line by means of a laser marking device, one or more inkjet printers or a numbering box. Alternatively, the printed product may also be individualized in the printing machine by systematically displacing one or more plate cylinders a certain distance such that each sheet carries an individual attribute.

However, it is not absolutely imperative that the printed product, of which the package is manufactured, carry the ID-code. The ID-code may also be located on the packaged item such that the dataset can only be recognized as being correct based on a combination of the ID-code on the packaged item and the 2D matrix code of the print data and/or paper data. This would solve the refill problem, i.e., the problem of placing a counterfeit article into a genuine package. In this case, the product is only verified as being genuine based on the combination of the packaged item and the package.

The packaged item naturally may also carry a code that is evaluated in accordance with the print quality and substrate quality criteria. Such a code could be applied on the product, for example, with inkjet printing.

It will be appreciated that the structures and process presented herein enable and new and more efficient manner to verify product authenticity. All references herein, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-49. (canceled)

50. A method for identifying attributes of printed products for their authentication and for tracking individual printed products or copies of printed products by scanning a printed code with an optoelectronic detection device, comprising:
a) applying a static code with redundant information and with high spatial resolution on the printed product,
b) executing optoelectronic detection of the printed image on the printed product via one of a line-scan or area-scan camera, a laser scanner within a printing machine and an additional processing machine, wherein the additional processing machine includes one of a web-fed or sheet-fed printing machine, a lift-punching machine, a punching machine with rotary tools, a folding box gluing machine, a collating machine for printed products, a packaging line, a machine for setting folding boxes upright, and a filling or packaging machine, and
c) decoding the detected image after acquisition via the optoelectronic detection device and using the decoded image to characterize an individual printed image and/or the printing process.

51. The method according to claim 50, wherein the decoding step is carried out after the acquisition of the image of the printed code, wherein the information contained in the code is determined based on an error correction and the variance caused by the printing process is subsequently determined based on the known sequence of symbols, wherein the systematic and the random component are distinguished from one another, and wherein the systematic component describes the quality of the printing process and the random component describes the uniqueness of the individual print.

52. The method according to claim 51, wherein a digital random signal is generated from the random component via one of a binary conversion with the threshold value of zero, and a multi-stage quantization.

53. The method according to claim 51, wherein the random signal is generated due to one of (1) an individual interaction of the printing ink on the printing substrate and (2) fluctuations of the ink splitting in the respective printing process.

54. The method according to claim 50, wherein at least part of the statically printed code is deliberately destroyed at one or more locations such that significantly higher random signal values than those generated due to the random signal caused by the stochastic fluctuations occur at these locations and are not taken into consideration during the subsequent decoding.

55. The method according to claim 54, wherein a non-canonical stochastic coding (nKSM) is obtained from the decoded values of the destroyed code and stored in order to once again locate the coded printed image or the coded copies of the printed image based on this coding.

56. The method according to claim 55, wherein an individual dataset of a corresponding code for identifying or authenticating a print can be quickly located in a database by means of the non-canonical stochastic coding (nKSM).

57. The method according to claim 55, wherein the non-canonical stochastic coding (nKSM) is associated with quality data of a printed image and the non-canonical stochastic coding (nKSM) is subsequently used for identifying each individual printed image/copy such that if fluctuations in the print quality are detected, defective printed images/copies are marked in an additional processing step.

58. The method according to claim 54, wherein the destruction of the code is carried out by one of a laser device, a spraying device that sprays colored or pigmented ink on the code, a striking tool, and a signature application that identifies the printed product as a unique printed product based on a combination of the manual marking and the printed code.

59. The method according to claim 50, wherein quality monitoring is carried out in connection with a canonical stochastic coding (KSM), wherein the probability of two canonical stochastic codings (KSM) no longer being distinguishable is estimated using known statistical methods.

60. The method according to claim 59, wherein the identification accuracy of the canonical stochastic coding (KSM) is output in the form of a parameter that is optically displayed on a machine control station of a printing machine, an additional processing machine, a separate display device or an acoustical or optical signal producing device.

61. The method according to claim 59, wherein prints with insufficient identification accuracy are identified and transferred out of the production flow at one site thereof based on a non-canonical stochastic coding (nKSM) or other marking.

62. The method according to claim 50, wherein the acquired and decoded data are coded with a secret key during the acquisition or in a separate cryptolographic step and can subsequently be re-decoded with a public key.

63. The method according to claim 62, wherein the coded data are stored in a database accesible via a mobile data connection or an Internet interface.

64. The method according to claim 50, wherein the printed static code is scanned by one of a scanner, a digital camera, a mobile telephone with integrated digital camera and an Internet camera in order to identify a printed product, and the recorded image is transmitted to an Internet-based database application that calculates at least one of the canonical stochastic coding (KSM) and the non-canonical stochastic coding (nKSM) to be matched to the stored data by using signal analysis methods.

65. The method according to claim 50, wherein the printed code with redundant information is realized in the form of a 2D matrix code.

66. The method according to claim 50, wherein the spatial resolution of the printed code used is chosen as a fraction of the maximum print resolution.

67. The method according to claim 50, wherein the printed code contains redundant information that allows error correction.

68. The method according to claim 50, wherein the printed code is composed of random geometric dots, wherein one geometric element of the printed code represents a logical one and another geometric element represents a logical zero and the laser beam is split into two orthogonal planes of polarization that are respectively formed by means of diffraction in accordance with the logical one and zero during the scanning process by means of the laser scanner, wherein the printed code is then scanned with the assembled new geometric figure of the laser beam spot formed substantially in accordance with the shapes of the printed codes, and wherein the different polarization directions are then recorded separately in the detector and the signals are subtracted and evaluated such that the laser scanner functions as a Matched-Filter-Detector.

69. The method according to claim 68, wherein the printed code is composed of oval dots, wherein the horizontal oval selectively represents a logical one and the vertical oval represents a logical zero, wherein the laser beam is split into two orthogonal planes of polarization that are respectively formed by means of diffraction in accordance with the logical one and zero during the scanning process by means of the laser scanner, and wherein the printed code is then scanned with the assembled cross of ovals of the laser beam spot.

70. The method according to claim 50, wherein the data rate transmitted to the decoding device is reduced to the symbol level such that a substantial data reduction is achieved in comparison with a conventional pixel-by-pixel evaluation.

71. The method according to claim 50, wherein printing the static code comprises one of offset printing with an offset printing machine that features at least one inking unit, one plate cylinder, one transfer cylinder and, if applicable, one or more varnishing units, and letterpress printing with a letterpress machine that features at least one inking unit and one plate cylinder, and flexographic letterpress printing with a letterpress machine that features at least one inking unit and one plate cylinder, and gravure printing with a gravure printing machine for web-fed and sheet-fed printing, and laser printing with a high-speed laser printing machine on substrates in the form of either webs or sheets, and inkjet printing wherein the printing takes place on substrates in the form of either webs or sheets.

72. The method according to claim 50, wherein values for distinguishing between the coding of the prints can be output on a display device in the printing machine or additional processing machine such that the monitoring of the ability to distinguish between the coding of the individual prints is displayed during the manufacturing process, wherein a warning signal is generated if a predetermined tolerance threshold with respect to the ability to distinguish between the codings is violated.

73. A device for identifying attributes of printed products for their authentication and for tracking individual printed products or copies of printed products by scanning a printed code with an optoelectronic detection device, comprising:
a) a printing device for applying a static code with redundant information and with high spatial resolution on the printed product in a printing machine or additional processing machine,
b) an optoelectronic detection device consisting of a line-scan or area-scan camera or a laser scanner within a printing machine or an additional processing machine such as a web-fed or sheet-fed printing machine or a lift-punching machine or a punching machine with rotary tools or a box-folding and gluing machine or a collating machine for printed products or a packaging line or a machine for setting folding boxes upright or in a filling or packaging machine, and
c) a data decoding device for processing the data delivered by the detection device, wherein the decoded data can be used for characterizing an individual print image and/or the printing process.

74. The device according to claim 73, wherein a display device is provided on the printing machine or additional processing machine, and wherein the values for the stochastic coding of the individual sheets can be displayed on said display device to enable distinguishing between the coding of individual copies.

75. The device according to claim 74, wherein a device is provided for the statistic calculation of values for false acceptance rates (FAR) and false rejection rates (FRR), and wherein these values are displayed on the display device, wherein a warning message is output in one of optical and acoustic form for excessively high false rejection rates.

76. The device according to claim 73, wherein the optoelectronic detection device consists of one of (1) a laser scanner that utilizes a telecentric image in order to improve the depth of field (2) a laser scanner, the spot of which is realized in the form of a signal-adapted filter, and (3) a laser scanner wherein the spot of the laser scanner is extended in accordance with the printed symbol used in the printed code, wherein the extension of the spot is achieved by diffraction gratings placed in the beam path.

77. The device according to claim 73, wherein a device for destroying the static code is provided in the printing machine or additional processing machine, the device consisting of one of a laser device, a spraying device.

78. A printed product manufactured according to the method of claim 50, wherein the product consists of one of (1) one or more folding box copies printed on a substrate in the form of a sheet or web in the printing machine, (2) one or more self-adhesive or wet-glue labels printed on a substrate in the form of a sheet or web in the printing machine, (3) one or more banknote or security copies printed on a substrate in the form of a sheet or web in the printing machine, wherein each copy carries a static code that is used for characterizing the individual print image and/or the printing process by means of a corresponding image acquisition and decoding of the thereby acquired data, and (4) one or more lottery tickets or coupons printed on a substrate in the form of a sheet or web in the printing machine, wherein each lottery ticket or coupon carries a static code that is used for characterizing the individual print image and/or the printing process by means of a corresponding image acquisition and decoding of the thereby acquired data.
